(19) United States
(12) Patent Application Publication
(10) Pub. No.: US 2016/0062690 A1
(43) Pub. Date: Mar. 3, 2016

(54) DATA STORAGE DEVICE, DATA PROCESSING SYSTEM INCLUDING THE SAME, AND OPERATING METHOD THEREOF

(71) Applicant: SK hynix Inc., Gyeonggi-do (KR)

(72) Inventors: Dong Jae SHIN, Gyeonggi-do (KR); Jong Ju PARK, Gyeonggi-do (KR); Seung Jin PARK, Gyeonggi-do (KR); Young Jin PARK, Gyeonggi-do (KR)

(21) Appl. No.: 14/609,177

(22) Filed: Jan. 29, 2015

(30) Foreign Application Priority Data
Aug. 27, 2014 (KR) 10-2014-0112347

(51) Int. Cl. G06F 3/06; G06F 1/32

(52) U.S. Cl. CPC G06F 3/0625; G06F 3/0679; G06F 3/0656; G06F 3/0634; G06F 1/3287

(57) ABSTRACT

A data processing system includes a host device including a first memory, and a data storage device including a second memory and a third memory, and suitable for storing data to be accessed by the host device, wherein the host device requests the data storage device to upload data stored in the second memory.

### CROSS-REFERENCES TO RELATED APPLICATION

The present application claims priority under 35 U.S.C. §119(a) to Korean application number 10-2014-0112347, filed on Aug. 27, 2014, in the Korean Intellectual Property Office, which is incorporated herein by reference in its entirety.

### BACKGROUND

1. Technical Field

Various embodiments of the present invention generally relate to a data processing system and, more particularly, to a data processing system which may back up data of a working memory of a data storage device in a working memory of a host device.

2. Related Art

The paradigm for the computer environment has shifted to ubiquitous computing so that computer systems can be used anytime, anywhere. The use of portable electronic devices such as mobile phones, digital cameras, and notebook computers has rapidly increased. In general, such portable electronic devices use a data storage device that incorporates memory devices. The data storage device stores data to be used in the portable electronic devices.

Data storage devices using memory devices may provide excellent stability, durability, high information access speed, and low power consumption, since there are no moving parts. Data storage devices having such advantages include universal serial bus (USB) memory devices, memory cards having various interfaces, universal flash storage (UFS) devices, and solid state drives (SSD).

### SUMMARY

Various embodiments of the present invention are directed to a data processing system that may back up data of a working memory of a data storage device in a working memory of a host device.

In an embodiment, a data processing system may include a host device including a first memory, and a data storage device including a second memory and a third memory, and suitable for storing data to be accessed by the host device, wherein the host device requests the data storage device to upload data stored in the second memory.

In an embodiment, a data storage device may include a nonvolatile memory device, a buffer memory device suitable for temporarily storing data to be transmitted from a host device to the nonvolatile memory device or from the nonvolatile memory device to the host device, and a controller including a working memory, and suitable for processing a request transmitted from the host device through driving of firmware stored in the working memory, wherein the controller transmits the firmware stored in the working memory to the host device based on an upload request transmitted from the host device.

In an embodiment, a method for operating a data processing system including a host device which includes a first working memory and a data storage device which includes a second working memory and a buffer memory may include requesting working memory data stored in the second working memory to be uploaded, storing uploaded working memory data in the first working memory, and requesting the data storage device to operate in a power save mode.

In an embodiment, a data storage device may include a nonvolatile memory device suitable for storing data to be accessed by a host device, a first memory device suitable for storing firmware, and a controller suitable for processing the data by driving the firmware based on a request transmitted from the host device, wherein the controller backs up the firmware from the first memory device to the host device before entering a power save mode, and downloads backed-up firmware from the host device to the first memory device after exiting from the power save mode.

### BRIEF DESCRIPTION OF THE DRAWINGS

FIG. 1 is a block diagram illustrating a data processing system in accordance with an embodiment.

FIG. 2 is a flow chart to assist in the explanation of the operations of the data processing system when entering a power save mode from a normal mode.

FIG. 3 is a flow chart to assist in the explanation of the operations of the data processing system when entering the normal mode from the power save mode.

FIG. 4 is a block diagram illustrating a data processing system in accordance with another embodiment.

FIG. 5 is a block diagram illustrating a data processing system including a solid state drive (SSD) in accordance with an embodiment.

FIG. 6 is a block diagram illustrating an SSD controller shown in FIG. 5.

### DETAILED DESCRIPTION

In the present invention, advantages, features and methods for achieving them will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concepts of the present invention.

It is to be understood herein that embodiments of the present invention are not limited to the particulars shown in the drawings and that the drawings are not necessarily to scale and, in some instances, proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “Including,” when used in this specification, specify the presence of at least one stated feature, step, operation, and/or element, but do not preclude the presence or addition of one or more other features, steps, operations, and/or elements thereof.

Hereinafter, a data storage device, a data processing system including the same, and an operating method thereof will be described with reference to the accompanying drawings through various embodiments of the present invention.

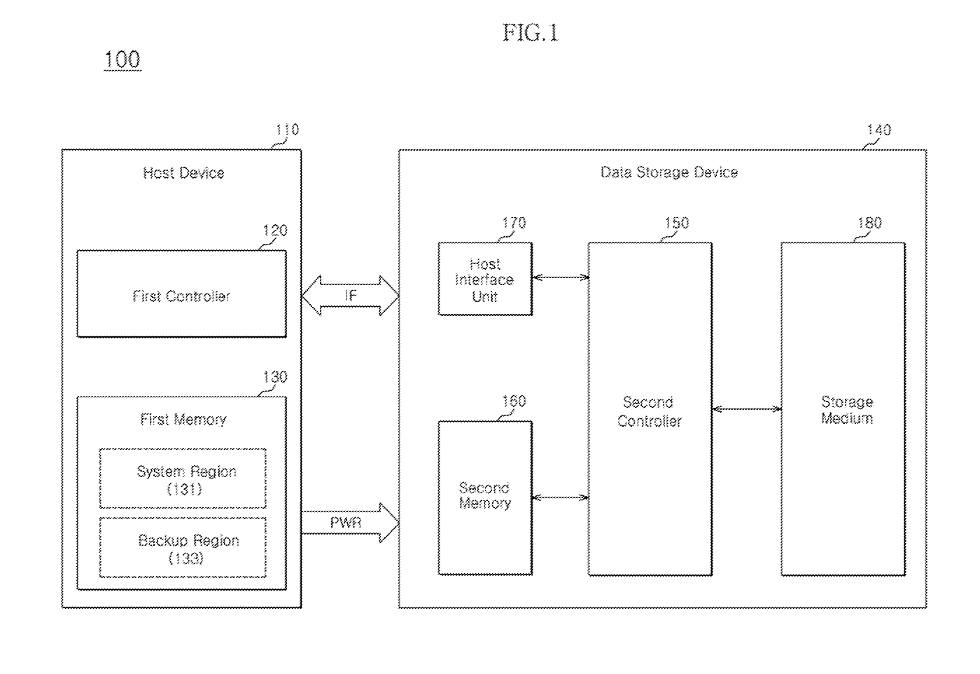

FIG. 1 is a block diagram illustrating a data processing system in accordance with an embodiment. Referring to FIG. 1, a data processing system 100 may include a host device 110, and a data storage device 140.

The host device 110 may include a portable electronic device such as a mobile phone, an MP3 player and a laptop computer or an electronic device such as a desktop computer, a game player, a TV and an in-vehicle infotainment system.

The host device 110 may include a first controller 120 and a first memory 130. While it is illustrated that the first memory 130 is configured outside the first controller 120, it is to be noted that the first memory 130 may be included in the first controller 120.

The first controller 120 may control the general operations of the host device 110 through driving of the firmware or software loaded on the first memory 130. The first controller 120 may decode and drive a code-type instruction or algorithm such as firmware or software. The first controller 120 may be realized in hardware or in a combination of hardware and software. The first controller 120 may be constituted by a micro control unit (MCU) or a central processing unit (CPU).

The first memory 130 may store the firmware or software to be driven by the first controller 120. Also, the first memory 130 may store data necessary for driving of the firmware or software. That is to say, the first memory 130 may operate as the working memory of the first controller 120.

For instance, the first memory 130 may be configured as a volatile random access memory such as a static random access memory (SRAM) and a dynamic random access memory (DRAM). For another instance, the first memory 130 may be configured as a nonvolatile random access memory such as a ferroelectric random access memory (FRAM), a magnetoresistive random access memory (MRAM), a phase change random access memory (PRAM) and a resistive random access memory (ReRAM).

The first memory 130 may be divided into a system region 131 and a backup region 133. The system region 131 may be a memory region which may be used as the work space of the first controller 120. The backup region 133 may be a memory region which may be used to back up the data of the data storage device 140 which operates in a power save mode. The first controller 120 may set a part of the memory region of the first memory 130 as the backup region 133, and may set the remaining region as the system region 131. The size of the backup region 133 may be fixed or changed each time the backup region 133 is set by the first controller 120.

The data storage device 140 may be manufactured as any one of various kinds of storage devices depending on the protocol of an interface IF through which it is electrically coupled with the host device 110. For example, the data storage device 140 may be configured as any one of various kinds of storage devices such as a solid state drive, a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a personal computer memory card international association (PCMCIA) card-type storage device, a peripheral component interconnection (PCI) card-type storage device, a PCI express (PCI-E) card-type storage device, a compact flash (CF) card, a smart media card, a memory stick, and so forth.

The data storage device 140 may be manufactured as any one of various kinds of package types. For example, the data storage device 140 may be manufactured as any one of various kinds of package types such as a package-on-package (POP), a system-in-package (SIP), a system-on-chip (SOC), a multi-chip package (MCP), a chip-on-board (COB), a wafer-level fabricated package (WFP) and a wafer-level stack package (WSP).

The data storage device 140 may store data to be accessed by the host device 110. The data storage device 140 may be referred as a memory system. The data storage device 140 may include a second controller 150, a second memory 160, a host interface unit 170, and a storage medium 180.

The second controller 150 may control the general operations of the data storage device 140 through driving of the firmware or software loaded on the second memory 160. The second controller 150 may decode and drive a code-type instruction or algorithm such as firmware or software. The second controller 150 may be realized in hardware or a combination of hardware and software. The second controller 150 may be constituted by a micro control unit (MCU) or a central processing unit (CPU).

The second memory 160 may store the firmware or software to be driven by the second controller 150. Also, the second memory 160 may store data necessary for driving of the firmware or software. That is to say, the second memory 160 may operate as the working memory of the second controller 150. The second memory 160 may temporarily store data to be transmitted from the host device 110 to the storage medium 180 or from the storage medium 180 to the host device 110. That is to say, the second memory 160 may operate as a buffer memory or a cache memory.

The second memory 160 may be logically divided and operate as a working memory and a buffer memory. In other words, a region of the second memory 160 may operate as a working memory, and the remaining region may operate as a buffer memory. Although the second memory 160 is shown as one memory, it is to be noted that the second memory 160 may be configured by a plurality of memories which are physically divided. In this case, one or more memories may operate as a working memory and a buffer memory.

For instance, the second memory 160 may be configured by a volatile random access memory such as a static random access memory (SRAM) and a dynamic random access memory (DRAM).

The host interface unit 170 may be configured to interface the host device 110 and the data storage device 140 based on the protocol of the interface IF. For instance, the host interface unit 170 may be configured by an interface unit which uses at least one of various interface protocols such as a universal serial bus (USB) protocol, a universal flash storage (UFS) protocol, a multimedia card (MMC) protocol, a peripheral component interconnection (PCI) protocol, a PCI express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The storage medium 180 may store data to be accessed by the host device 110. For instance, the storage medium 180 may be configured by any one of various types of nonvolatile memory devices such as a NAND flash memory device, a NOR flash memory device, a ferroelectric random access memory (FRAM) using a ferroelectric capacitor, a magnetoresistive random access memory (MRAM) using a tunneling magnetoresistance (TMR) layer, a phase change random access memory (PRAM) using a chalcogenide alloy, and a resistive random access memory (ReRAM) using a transition metal oxide. The storage medium 180 may be configured by a combination of a NAND flash memory device and one or more of the various types of nonvolatile memory devices described above.

In the case where the storage medium 180 is configured by one or more of the various types of nonvolatile memory devices described above, the storage medium 180 may be referred to as a third memory.

The data storage device 140 which operates in a power save mode, such as a sleep mode, and a power-down mode may interrupt power supply to or supply only standby power to the remaining function blocks (the second controller 150, the second memory 160 and the storage medium 180) excluding the host interface unit 170, to reduce power consumption. Thus, the data stored in the second memory 160 should be backed up in a safe place so as not to be lost.

The host device 110 may request the data storage device 140 to upload the data stored in the second memory 160, before requesting the data storage device 140 to enter the power save mode. The host device 110 may store uploaded data in the backup region 133 of the first memory 130. The host device 110 may request the data storage device 140 to download the data stored in the backup region 133 of the first memory 130, after requesting for the data storage device 140 to wake up, that is, to exit from the power save mode. Operation flows of the host device 110 and the data storage device 140 for performing the upload operation and the download operation for the data stored in the second memory 160 will be described below in detail with reference to drawings.

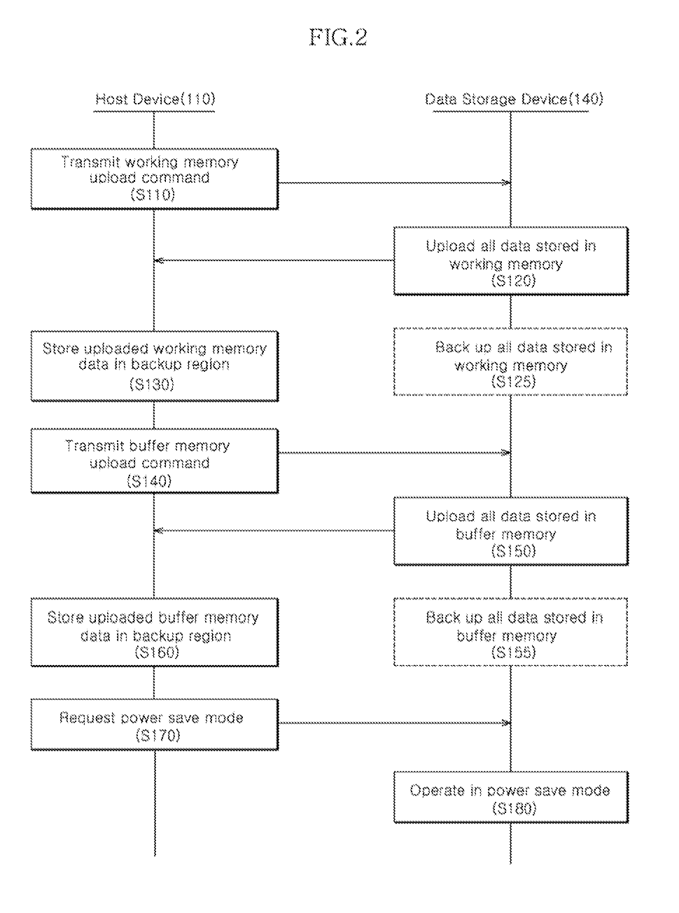

FIG. 2 is a flow chart to assist in the explanation of the operations of the data processing system 100 when entering a power save mode from a normal mode.

As described above, the second memory 160 of the data storage device 140 may be logically or physically divided and operate as a working memory and a buffer memory. In describing FIG. 2, it will be explained as an example that the second memory 160 is physically divided into a working memory and a buffer memory.

An entry from a normal mode to a power save mode may be made in the entire data processing system 100, or may be made in some of the components which configure the data processing system 100. In describing FIG. 2, it will be explained as an example that only the data storage device 140 enters the power save mode.

At step S110, the host device 110 may transmit a working memory upload command to the data storage device 140 to allow the data storage device 140 to upload the data stored in the working memory.

At step S120, the data storage device 140 may upload all data stored in the working memory (hereinafter, referred to as working memory data) to the host device 110, in response to the working memory upload command from the host device 110.

At step S130, the host device 110 may store the uploaded working memory data in the backup region 133 of the first memory 130.

At step S140, the host device 110 may transmit a buffer memory upload command to the data storage device 140 to allow the data storage device 140 to upload the data stored in the buffer memory.

At step S150, the data storage device 140 may upload all data stored in the buffer memory (hereinafter, referred to as buffer memory data) to the host device 110, in response to the buffer memory upload command from the host device 110.

At step S160, the host device 110 may store the uploaded buffer memory data in the backup region 133 of the first memory 130.

At step S170, the host device 110 may request the data storage device 140 to enter the power save mode.

At step S180, the data storage device 140 may operate in the power save mode after completing work for entering the power save mode in response to the power save mode request from the host device 110.

If the working memory data and the buffer memory data are backed up in the host device 110 according to the requests (that is, the working memory upload request and the buffer memory upload request) from the host device 110, the data storage device 140 may quickly enter the power save mode. Namely, the data storage device 140 may omit operations of storing the working memory data and the buffer memory data in the storage medium 180 to be ready for the power save mode, for example, operations at steps S125 and S155. Also, the data storage device 140 may omit work to be completed before entering the power save mode, for example, a write operation for the buffer memory data.

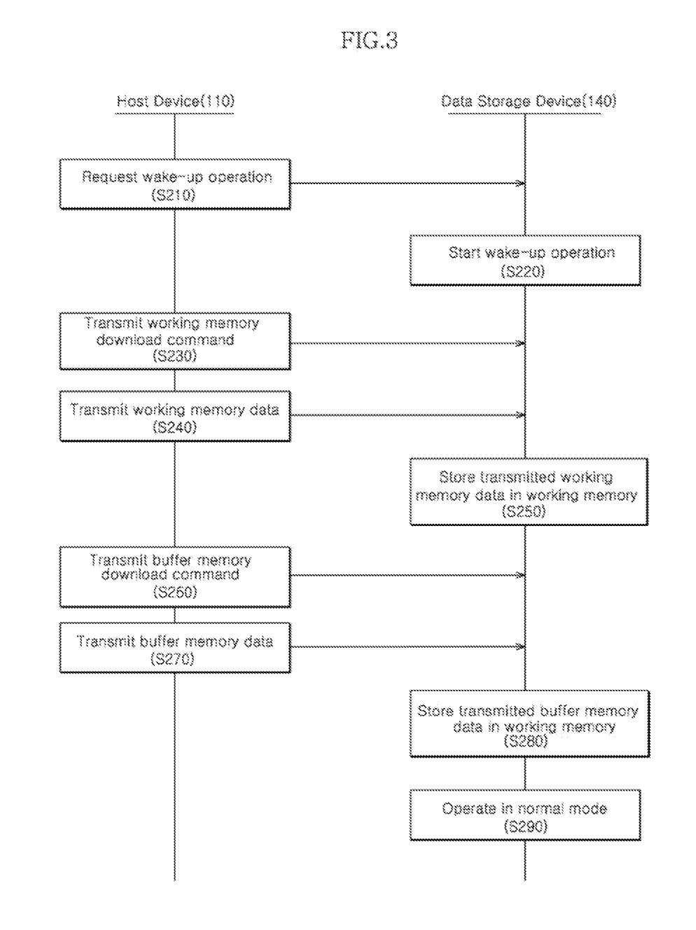

FIG. 3 is a flow chart to assist in the explanation of the operations of the data processing system 100 when entering the normal mode from the power save mode. In describing FIG. 3, it will be explained as an example that the working memory data and the buffer memory data of the data storage device 140 are backed up in the host device 110 according to the operations described in FIG. 2.

At step S210, the host device 110 may request the data storage device 140 to wake up to allow the data storage device 140 to return from the power save mode to the normal mode. The wake-up request may be made using software or hardware.

At step S220, the data storage device 140 may start a wake-up operation in response to the wake-up request. For instance, the data storage device 140 may supply power to and activate function blocks such that all function blocks (for example, the second controller 150, the second memory 160 and the storage medium 180) are activated.

At step S230, the host device 110 may transmit a working memory download command to the data storage device 140 to allow the data storage device 140 to receive the working memory data.

Although not shown, the data storage device 140 may notify the host device 110 when it is possible to receive data, in response to the working memory download command from the host device 110.

At step S240, the host device 110 may transmit the working memory data, stored in the backup region 133 of the first memory 130, to the data storage device 140.

At step S250, the data storage device 140 may store the transmitted working memory data in the working memory.

At step S260, the host device 110 may transmit a buffer memory download command to the data storage device 140 to allow the data storage device 140 to receive the buffer memory data.

Although not shown, the data storage device 140 may notify the host device 110 when it is possible to receive data, in response to the buffer memory download command from the host device 110.

At step S270, the host device 110 may transmit the buffer memory data, stored in the backup region 133 of the first memory 130, to the data storage device 140.

At step S280, the data storage device 140 may store the transmitted buffer memory data in the buffer memory.

At step S290, the data storage device 140 may operate in the normal mode.

If the working memory data and the buffer memory data backed up in the host device 110 are downloaded to the data storage device 140 according to the requests (that is, the working memory download request and the buffer memory download request) from the host device 110, the data storage device 140 may enter the normal mode as the same state before the entry to the power save mode is made.

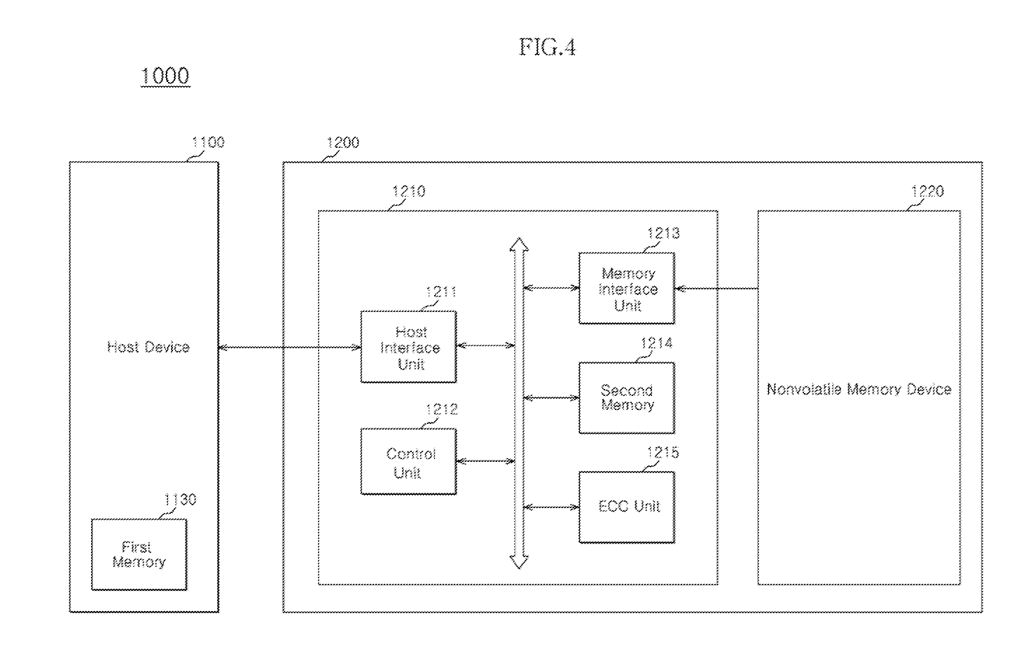

FIG. 4 is a block diagram illustrating a data processing system in accordance with another embodiment. Referring to FIG. 4, a data processing system 1000 may include a host device 1100 and a data storage device 1200.

The data storage device 1200 may include a controller 1210, and a nonvolatile memory device 1220. The data storage device 1200 may be used by being electrically coupled to the host device 1100 such as a mobile phone, an MP3 player, a laptop computer, a desktop computer, a game player, a TV, an in-vehicle infotainment system, and so forth.

The controller 1210 may be configured to access the nonvolatile memory device 1220 in response to a request from the host device 1100. For example, the controller 1210 may be configured to control the read, program or erase operations of the nonvolatile memory device 1220. The controller 1210 may be configured to drive firmware or software for controlling the nonvolatile memory device 1220.

The controller 1210 may include a host interface unit 1211, a control unit 1212, a memory interface unit 1213, a second memory 1214, and an error correction code (ECC) unit 1215.

The control unit 1212 may be configured to control the general operations of the controller 1210 in response to a request from the host device 1100. The second memory 1214 may be used as the working memory of the control unit 1212. The second memory 1214 may be used as a buffer memory which temporarily stores the data read from the nonvolatile memory device 1220 or the data provided from the host device 1100.

The host interface unit 1211 may be configured to interface the host device 1100 and the controller 1210. For example, the host interface unit 1211 may be configured to communicate with the host device 1100 through one of various interface protocols such as a universal serial bus (USB) protocol, a universal flash storage (UFS) protocol, a multimedia card (MMC) protocol, a peripheral component interconnection (PCI) protocol, a PCI express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The memory interface unit 1213 may be configured to interface the controller 1210 and the nonvolatile memory device 1220. The memory interface unit 1213 may be configured to provide commands and addresses to the nonvolatile memory device 1220. Furthermore, the memory interface unit 1213 may be configured to exchange data with the nonvolatile memory device 1220.

The memory interface unit 1213 may be configured to interface the controller 1210 and the nonvolatile memory device 1220. The memory interface unit 1213 may be configured to provide commands and addresses to the nonvolatile memory device 1220. Furthermore, the memory interface unit 1213 may be configured to exchange data with the nonvolatile memory device 1220.

The error correction code unit 1215 may be configured to detect an error of the data read from the nonvolatile memory device 1220. Also, the error correction code unit 1215 may be configured to correct the detected error when the detected error is within a correctable range.

The nonvolatile memory device 1220 may be used as the storage medium of the data storage device 1200. The nonvolatile memory device 1220 may include a plurality of nonvolatile memory chips (or dies).

The host device 1100 may request the data storage device 1200 to upload the data stored in the second memory 1214 before requesting the data storage device 1200 to enter a power save mode. The host device 1100 may store uploaded data in a first memory 1130. The host device 1100 may request the data storage device 1200 to download the data stored in the first memory 1130 after requesting the data storage device 1200 to wake up and exit from the power save mode.

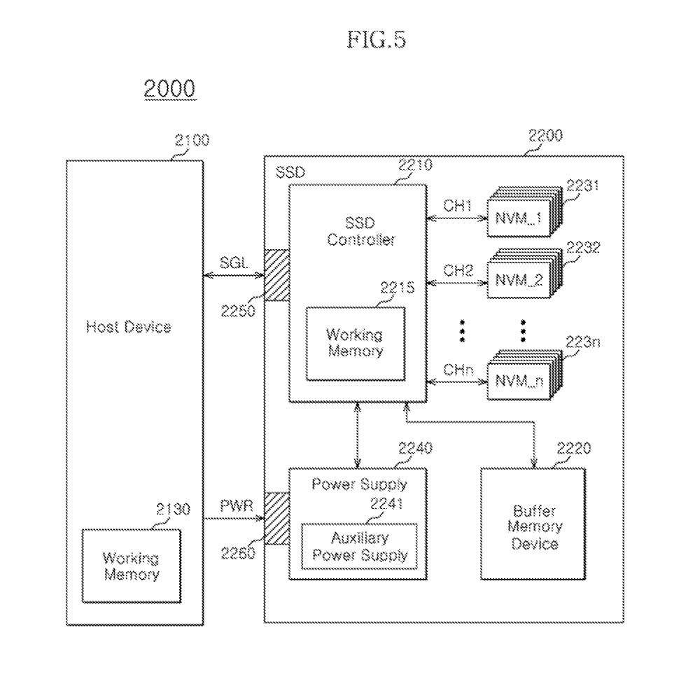

FIG. 5 is a block diagram illustrating a data processing system including a solid state drive (SSD) in accordance with an embodiment. Referring to FIG. 5, a data processing system 2000 may include a host device 2100 and a solid state drive (SSD) 2200.

The SSD 2200 may include an SSD controller 2210, a buffer memory device 2220, nonvolatile memory devices 2231 to 223n, a power supply 2240, a signal connector 2250, and a power connector 2260.

The SSD controller 2210 may be configured to access the nonvolatile memory devices 2231 to 223n in response to a request from the host device 2100. For example, the SSD controller 2210 may be configured to control the read, program and erase operations of the nonvolatile memory devices 2231 to 223n. To this end, the SSD controller 2210 may drive firmware or software. A working memory 2215 may be used as the working memory of the SSD controller 2210 to store the firmware or software.

The buffer memory device 2220 may be configured to temporarily store data which are to be stored in the nonvolatile memory devices 2231 to 223n. Further, the buffer memory device 2220 may be configured to temporarily store data which are read from the nonvolatile memory devices 2231 to 223n. The data temporarily stored in the buffer memory device 2220 may be transmitted to the host device 2100 or the nonvolatile memory devices 2231 to 223n under the control of the SSD controller 2210.

The nonvolatile memory devices 2231 to 223n may be used as the storage media of the SSD 2200. The nonvolatile memory devices 2231 to 223n may be electrically coupled to the SSD controller 2210 through a plurality of channels CH1 to CHn, respectively. One or more nonvolatile memory devices may be electrically coupled to one channel. The nonvolatile memory devices electrically coupled to one channel may be electrically coupled to the same signal bus and data bus.

The power supply 2240 may be configured to provide power PWR, inputted through the power connector 2260, to the inside of the SSD 2200. The power supply 2240 may include an auxiliary power supply 2241. The auxiliary power supply 2241 may be configured to supply power to allow the SSD 2200 to be properly shut down when a sudden power-off occurs. The auxiliary power supply 2241 may include super capacitors capable of being charged with the power PWR.

The SSD controller 2210 may exchange a signal SGL with the host device 2100 through the signal connector 2250. The signal SGL may include a command, an address, data, and so forth. The signal connector 2250 may be configured as one of several connectors for various protocols such as parallel advanced technology attachment (PATA), serial advanced technology attachment (SATA), small computer system interface (SCSI), serial attached SCSI (SAS), peripheral component interconnection (PCI) and PCI express (PCI-E) protocols, depending on the interface scheme between the host device 2100 and the SSD 2200.

The host device 2100 may request the SSD 2200 to upload the data stored in the working memory 2215 and the data stored in the buffer memory device 2220, before requesting the SSD 2200 to enter a power save mode. The host device 2100 may store uploaded data in its working memory 2130. The host device 2100 may request the SSD 2200 to download the data stored in the working memory 2130, after requesting the SSD 2200 to wake up.

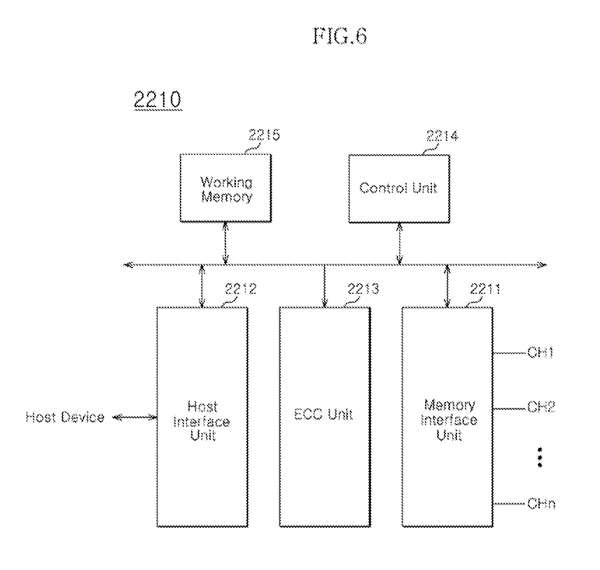

FIG. 6 is a block diagram illustrating the SSD controller 2210 shown in FIG. 5. Referring to FIG. 6, the SSD controller 2210 may include a memory interface unit 2211, a host interface unit 2212, an error correction code (ECC) unit 2213, a control unit 2214, and the working memory 2215.

The memory interface unit 2211 may be configured to provide a control signal such as a command and an address to the nonvolatile memory devices 2231 to 223n. Moreover, the memory interface unit 2211 may be configured to exchange data with the nonvolatile memory devices 2231 to 223n. The memory interface unit 2211 may scatter the data transmitted from the buffer memory device 2220 to the channels CH1 to CHn, under the control of the control unit 2214. Furthermore, the memory interface unit 2211 may transmit the data read from the nonvolatile memory devices 2231 to 223n to the buffer memory device 2220, under the control of the control unit 2214.

The host interface unit 2212 may be configured to provide an Interface with the SSD 2200 in correspondence to the protocol of the host device 2100. For example, the host interface unit 2212 may be configured to communicate with the host device 2100 through one of parallel advanced technology attachment (PATA), serial advanced technology attachment (SATA), small computer system interface (SCSI), serial attached SCSI (SAS), peripheral component interconnection (PCI) and PCI express (PCI-E) protocols. In addition, the host interface unit 2212 may perform a disk emulating function of supporting the host device 2100 to recognize the SSD 2200 as a hard disk drive (HDD).

The ECC unit 2213 may be configured to generate parity bits based on the data transmitted to the nonvolatile memory devices 2231 to 223n. The generated parity bits may be stored in spare areas of the nonvolatile memory devices 2231 to 223n. The ECC unit 2213 may be configured to detect an error of the data read from the nonvolatile memory devices 2231 to 223n. When the detected error is within a correctable range, the ECC unit 2213 may be configured to correct the detected error.

The control unit 2214 may be configured to analyze and process the signal SGL inputted from the host device 2100. The control unit 2214 may control the general operations of the SSD controller 2210 in response to a request from the host device 2100. The control unit 2214 may control the operations of the buffer memory device 2220 and the nonvolatile memory devices 2231 to 223n based on firmware for driving the SSD 2200. The working memory 2215 may be used as a working memory for driving the firmware.

As is apparent from the above descriptions, according to the embodiments, because data of a working memory of a data storage device may be backed up in a working memory of a host device, the performance of a data processing system may be improved.

While various embodiments have been described above, it will be understood to those skilled in the art that the embodiments described are examples only. Accordingly, the data storage device, the data processing system including the same, and the operating method thereof described herein should not be limited based on the described embodiments.

What is claimed is:

1. A data processing system comprising:
a host device including a first memory; and
a data storage device including a second memory and a third memory, and suitable for storing data to be accessed by the host device,
wherein the host device requests the data storage device to upload data stored in the second memory.

2. The data processing system according to claim 1, wherein the host device stores data uploaded from the data storage device in the first memory.

3. The data processing system according to claim 2, wherein the host device requests the data storage device to enter a power save mode after storing the data uploaded form the data storage device in the first memory.

4. The data processing system according to claim 3, wherein the host device requests the data storage device to download data stored in the first memory, after requesting the data storage device to wake up from the power save mode.

5. The data processing system according to claim 4, wherein the data storage device stores data downloaded from the host device in the second memory.

6. The data processing system according to claim 1, wherein the second memory is divided logically or physically into a working memory and a buffer memory.

7. The data processing system according to claim 6, wherein the host device requests the data storage device to upload data stored in the working memory.

8. The data processing system according to claim 6, wherein the host device requests the data storage device to upload data stored in the buffer memory.

9. The data processing system according to claim 1,
wherein the first memory comprises a volatile memory or a nonvolatile memory,
wherein the second memory comprises a volatile memory, and
wherein the third memory comprises a nonvolatile memory.

10. A data storage device comprising:
a nonvolatile memory device;
a buffer memory device suitable for temporarily storing data to be transmitted from a host device to the nonvolatile memory device or from the nonvolatile memory device to the host device; and
a controller including a working memory, and suitable for processing a request transmitted from the host device through driving of firmware stored in the working memory,
wherein the controller transmits the firmware stored in the working memory to the host device, based on an upload request transmitted from the host device.

11. The data storage device according to claim 10, wherein the nonvolatile memory device, the buffer memory device, and the controller operate in a power save mode, based on a power save mode request transmitted from the host device, after the firmware is transmitted.

12. The data storage device according to claim 11, wherein the nonvolatile memory device, the buffer memory device, and the controller are activated, based on a wake-up request transmitted from the host device.

13. The data storage device according to claim 12, wherein the controller stores firmware transmitted from the host device in the working memory, based on a download request transmitted from the host device.

14. The data storage device according to claim 10, wherein the controller transmits buffer memory data stored in the buffer memory device to the host device, based on the upload request.

15. The data storage device according to claim 14, wherein the controller stores buffer memory data transmitted from the host device in the buffer memory device, based on a download request transmitted from the host device.

16. A method for operating a data processing system including a host device which includes a first working memory and a data storage device which includes a second working memory and a buffer memory, the method comprising:
requesting working memory data stored in the second working memory to be uploaded;
storing the uploaded working memory data in the first working memory; and
requesting the data storage device to operate in a power save mode.

17. The method according to claim 16, further comprising:
requesting the data storage device to wake-up from the power save mode.

18. The method according to claim 17, further comprising:
requesting the working memory data stored in the first working memory to be downloaded; and
storing the downloaded working memory data in the second working memory.

19. The method according to claim 16, further comprising:
requesting buffer memory data stored in the buffer memory to be uploaded; and
storing uploaded buffer memory data in the first working memory.

20. The method according to claim 19, further comprising:
requesting buffer memory data stored in the first working memory to be downloaded; and
storing downloaded buffer memory data in the buffer memory.
